(19) United States
(12) Patent Application Publication
(10) Pub. No.: US 2024/0389568 A1
(43) Pub. Date: Nov. 28, 2024

(54) DIVIDABLE HORSESHOE ACCOMMODATING TRANSVERSE PIVOTING OF HORSESHOE LEGS

(71) Applicant: EQUINOVUM LLC, Burlington, WI (US)

(72) Inventors: Bart HALSBERGHE, Belgium (BE); Bart VERNAILLEN, Jabbeke (BE); Bart DECROOS, Jabbeke (BE); ERIC NIELSEN, Burlington, WI (US)

(21) Appl. No.: 18/260,212

(22) PCT Filed: Dec. 30, 2021
(86) PCT No.: PCT/US2021/065661

§ 371 Date: Jun. 30, 2023

(30) Foreign Application Priority Data
Dec. 31, 2020 (US) 63132615

(51) Int. Cl. A01L 1/04

(52) U.S. Cl. CPC A01L 1/04

(57) ABSTRACT

A dividable horseshoe is provided that is divided in a horse shoeing cycle, either during or after a shoeing procedure, and accommodates resilient hoof flexing about multiple planes to allow the hoof mechanism to perform substantially similar to a barefoot hoof. The dividable horseshoe includes at least one clearance at a bridge that gets divided, with the clearance(s) facilitating substantial multiaxial movements of forward horseshoe leg ends with respect to and without colliding with each other in a manner that avoids restriction of contraction and expansion of a hoofs heel.

### CROSS-REFERENCE TO RELATED APPLICATIONS

This international application claims the benefit of and priority to U.S. Provisional Application No. 63/132,615 filed Dec. 31, 2020, which is incorporated herein by reference in its entirety.

### FIELD OF THE INVENTION

The invention relates generally to horseshoes.

### BACKGROUND OF THE INVENTION

Healthy hooves are critically important to the overall wellbeing of horses. Although seemingly rigid, under the weight-bearing stance phase and gait-induced loads of horses, hooves are instead flexible and adaptable. A hoof's flexibility and adaptability provide a hoof mechanism that cyclically undergoes resilient or visco-elastic three-dimensional self-reversing deformations. The hoof mechanism stimulates blood circulation through the hoof, ensures good hoof quality and growth, increases shock-absorption at impact, and maintains natural biomechanics of the lower limb.

Horseshoes are used to protect hooves from excessive wear and damage, to help with shock-absorption, to improve traction, or to correct conformational or hoof/limb-related medical problems. Correspondingly, horseshoes are especially useful for horses that are highly active, frequently walk on hard surfaces, have hoof damage, or certain hoof abnormalities, and sustained injuries of the musculoskeletal system.

Although typical horseshoes provide such protection and corrective benefits, they can compromise the natural workings of the hoof mechanism. That is because a typical horseshoe is a one-piece rigid device that is attached to the bottom of a hoof, which restricts the natural flexibility and adaptability of the hoof mechanism. Heel expansion and other heel movement(s), lateral flexibility, and sagittal flexibility, are typically reduced substantially on a shod horse.

Attempts have been made to provide the benefits of typical horseshoes while being less restrictive to the hoof mechanism's natural functions that require hoof flexibility and adaptability.

These attempts include horseshoes with flexible bridges at their toe segments that allow at least some hoof flexibility. However, these designs can be expensive and challenging to fit because they freely bend while being manipulated during shoeing. Horseshoes with flexible bridges are also susceptible to breaking at their flexible bridges, at times even while shoeing, making the broken shoes unusable because they are unable to reliably stay fixed to the hoof.

Some proposed horseshoes are supposed to purposefully but passively break, for example, at a line of weakness, under the stresses experienced during normal activity of the shod horse. Although a break tends to occur generally at the line of weakness, in a pre-weakened horseshoe that is attached to a hoof, the particular crack or fracture location and shape is uncontrollable. These fractures tend to leave irregular or at least somewhat jagged surfaces and sharp edges that can lead to pinching, cutting, or other injuries. Although a passively broken horseshoe may theoretically allow at least some independent vertical movements of its two halves, the edges at the broken line of weakness or fracture line would be in face-to-face abutment with each other. The face-to-face abutments at the fracture lines act as mechanical stops that prevent hoof expansion, contraction, and yaw-type (Z-axis) pivot movement or transverse pivoting of the halves with respect to each other.

Some attempts to facilitate a horseshoe's passive breaking includes creating wide/large weakened areas or regions by removing substantial amounts of material to form large recesses at the horseshoe toes' inner circumferences. Although these large, weakened, regions are more susceptible to fracturing, the substantial amount(s) of material removed from the inner circumference compromises the horseshoe's hoof support. Since a typical horseshoe has a material width as a distance between its inner and outer circumference of about 20 mm, ranging between 15 mm-30 mm and, more typically, between 18 mm-24 mm at the toe and a typical hoof has a hoof wall thickness of about 10 mm to 12 mm at the toe, about 50% of the horseshoe's material width between the horseshoe's inner and outer circumference is inward of the hoof wall and covers a corresponding portion of the sole. In horseshoes that are configured to passively break with substantial amounts of material removed to create large recesses with, for example, widths of between about 15 mm to 60 mm and up to about 50% of the distances between the horseshoe's inner and outer circumferences, the portion of the hoof's sole that would otherwise be covered by the horseshoe is fully unsupported at the recess. However, sole support is very important during a hoof's landing and during hoof loading because the sole is able to spread the weight impact on landing because the sole is able to spread the weight impact/load on landing and during hoof loading over a larger area. If there is no sole support, then the full impact and load will be transmitted to the hoof wall, which can eventually lead to hoof wall damage. This is related to the fact that the hoof wall is not designed to be the only weight bearing structure. Rather, nature designed the hoof so the hoof wall and sole would share the load to disperse the forces during impact and loading.

Another attempt includes dividing a horseshoe while shoeing, after it is fit to a hoof. Since the dividing is typically done with a saw or grinder, a kerf-gap is provided between the two halves. This allows for greatly improved expansion, contraction, and yaw-type or transverse pivot movement of the halves with respect to each other. However, expansion, contraction, or pivot movements are limited at a certain point, with further movement(s) prevented by transverse kerf edge engagement or by the forward or rearward corners of the halves colliding with each other while, for example, the hoof urges toward passively flexing and adapting to the terrain in its natural way.

### SUMMARY OF THE INVENTION

The invention provides a horseshoe that allows a horse's hoof mechanism to perform, e.g., resiliently flex, substantially similar to a barefoot hoof. This is done while maintaining all the benefits of horseshoes, including protecting hooves from excessive wear and damage, helping with shock-absorption, improving traction, and correcting conformational or hoof/limb-related medical problems.

In accordance with an aspect of the invention, a dividable horseshoe is provided that accommodates the resilient hoof flexing about multiple planes.

In accordance with an aspect of the invention, a dividable horseshoe is provided that allows hoof flexing about three axes arranged in an X-plane, and Y-plane, and a Z-plane that are orthogonal with respect to each other or in three-dimensions.

In accordance with another aspect of the invention, the dividable horseshoe is converted from a one-piece horseshoe into a two-piece horseshoe during a horse shoeing procedure. The resultant horseshoe halves can move vertically and horizontally with respect to each other or pivot in a yaw-type or transverse pivoting movement toward or away from each other. Permitting vertical movement of the horseshoe halves with respect to each other facilitates natural deformations of portions of a hoof with vertical movement components, such as those experienced during turns or when engaging uneven terrain. Permitting horizontal movement of the horseshoe halves with respect to each other facilitates natural deformations of portions of a hoof with horizontal movement components, such as those experienced during a hoof's natural expansion and contraction of the hoof mechanism.

In accordance with another aspect of the invention, the dividable horseshoe may include at least one clearance that extend into at least one of a forward bridge wall and a rearward bridge wall at a bridge that connects the horseshoe's two side legs to each other when in a one-piece configuration. When split or divided into a two-piece configuration, the clearance segments at each of the halves provide room for articulation of the halves with respect to each other, facilitating transverse pivoting of the halves during heel contraction and expansion.

In accordance with another aspect of the invention, the clearances remove as little material as possible from the horseshoe, only enough material to obtain the desired amount of heel contraction and expansion. This facilitates the hoof's natural expansion and contraction of the hoof mechanism without compromising optimum hoof wall support and sole support by providing sufficient material to engage and support these hoof structures, immediately adjacent the clearances.

It is therefore an object of at least one embodiment of the invention to provide a dividable horseshoe that, after it has been divided, accommodates both hoof expansion and contraction.

It is another object of at least one embodiment of the invention to provide a dividable horseshoe that allows sufficient degrees of freedom of movement for a hoof to passively conform to a ground surface to facilitate dissipation of ground reaction forces at the hoof in a manner that is substantially similar to a barefoot hoof.

In accordance with another aspect of the invention, if the dividable horseshoe is configured for securing to the hoof by gluing, it may include multiple surfaces which may be arranged in multiple planes for applying adhesive to bond the hoof to the horseshoe in a corresponding multi-plane bonding arrangement. If the dividable horseshoe is configured for securing to the hoof by nailing or screwing, it may include at least four holes at each leg of the horseshoe to provide a variety of nailing position options when shoeing as well as options for how many nails to use secure the dividable horseshoe to the hoof.

In accordance with another aspect of the invention, the dividable horseshoe may include at least two toe clips at the toe segment and at least two side clips at the side segments or legs of the horseshoe. The toe and side clips help hold each of the halves of the horseshoe in the divided state in a manner that reduces torque and other stresses or shear forces on the nails. The toe clips may be a pair of toe clip segments that initially defined a single toe clip when the dividable horseshoe is in the one-piece configuration, which is divided to provide the toe clip segments or pair of toe clips when the dividable horseshoe is in the two-piece configuration.

It is therefore an object of at least one embodiment of the invention to provide a dividable horseshoe that accommodates hoof expansion and/or contraction while maintaining the integrity of the securement of the horseshoe halves to the hoof.

These and other features and aspects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the scope of the invention.

### BRIEF DESCRIPTION OF THE DRAWINGS

FIG. 1 is a pictorial view from above of a dividable horseshoe in an accordance with an aspect of the invention;

FIG. 2 is a pictorial view from below of the dividable horseshoe of FIG. 1;

FIG. 3 is a top plan view of the dividable horseshoe of FIG. 1;

FIG. 4 is a bottom plan view of the dividable horseshoe of FIG. 1;

FIG. 5 is a top plan view of a bridge of the dividable horseshoe of FIG. 1;

FIG. 6 is a top plan view of a bridge of a variant of the dividable horseshoe of FIG. 1;

FIG. 7 is a top plan view of a bridge of another variant of the dividable horseshoe of FIG. 1;

FIG. 8 is a top plan view of a bridge of another variant of the dividable horseshoe of FIG. 1;

FIG. 9 is pictorial view from below of a bridge of the dividable horseshoe of FIG. 1;

FIG. 10 is pictorial view from above of the bridge of the dividable horseshoe of FIG. 1;

FIGS. 11-14 are pictorial views from above of different stages of preliminary cuts to the dividable horseshoe of FIG. 1;

FIG. 15 is a pictorial view from below of a final cutting or separating stage of the dividable horseshoe of FIG. 1;

FIG. 16 is pictorial view from below after a final cutting or separating stage shown in FIG. 15, with the dividable horseshoe of FIG. 1 defining a two-piece configuration;

FIG. 17 is a top plan view before a preliminary cut at a cut groove;

FIG. 18 is a top plan view after a first preliminary cut at a cut groove;

FIG. 19 is a top plan view after a second preliminary cut at a cut groove;

FIG. 20 is a rear elevation view after a third preliminary cut at a cut groove;

FIG. 21 is a rear elevation view after a fourth preliminary cut at a cut groove;

FIG. 22 is a top plan view after a final cutting or separating stage, defining a two-piece configuration;

FIG. 23 is a top plan view showing a divided bridge in a default or neutral state;

FIG. 24 is a top plan view showing the divided bridge of FIG. 23 in a contracted heel state;

FIG. 25 is another top plan view showing a divided bridge in a default or neutral state;

FIG. 26 is a top plan view showing the divided bridge of FIG. 25 in an expanded heel state;

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE PREFERRED EMBODIMENTS

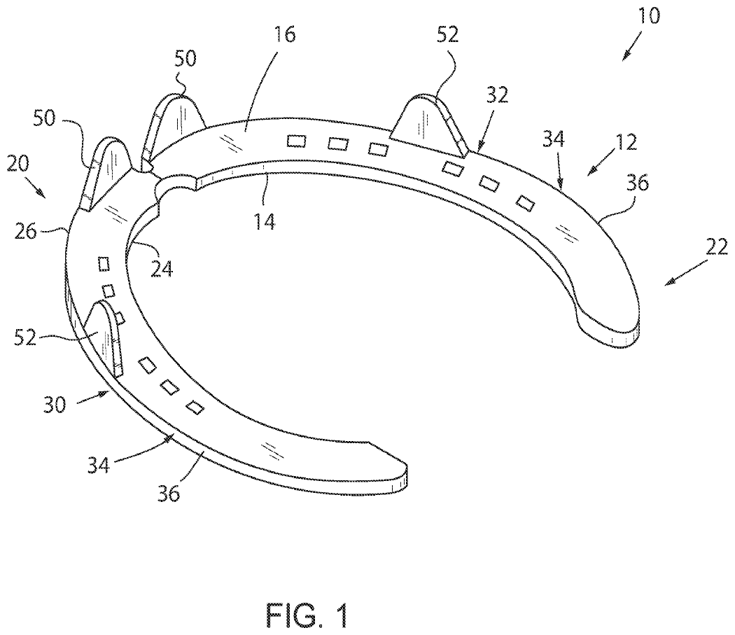

Referring now to the drawings and initially to FIG. 1, a dividable horseshoe is shown as horseshoe 10. Horseshoe 10 is dividable from a one-piece horseshoe 10 (FIG. 1, shown from a support side) into a two-piece horseshoe 10 (FIG. 16, shown from a ground side) during a horse shoeing procedure in which it is attached to a horse's hoof during an initial hoof-care session of a horse shoeing cycle or during a subsequent hoof-care session during the horse shoeing cycle. When in the two-piece horseshoe configuration, the independent halves of horseshoe 10 allows the horse's hoof mechanism to perform, e.g., resiliently flex, substantially similar to a barefoot hoof.

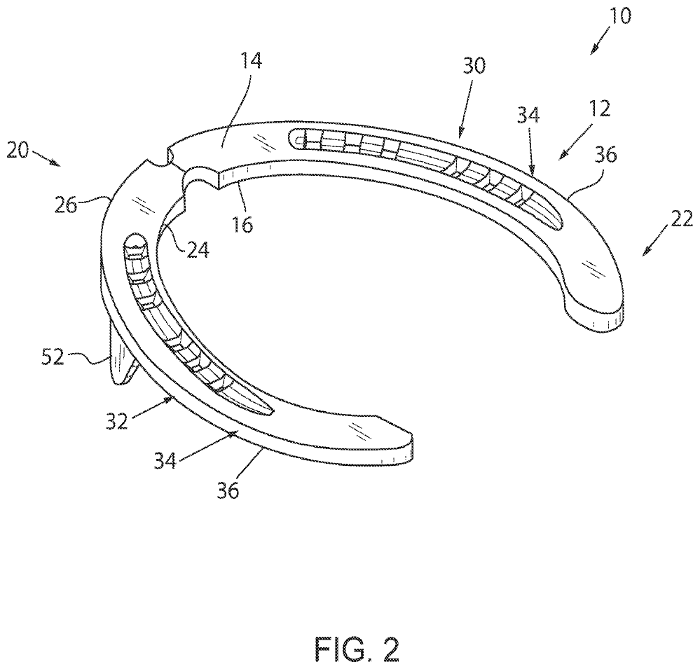

Referring now to FIGS. 1 and 2, horseshoe 10 defines a body 12 that provides a ground-facing surface, shown as ground surface 14 and a support surface 16. The horseshoe 10 in FIG. 1 is shown right-side up, with the support surface 16 facing up, and FIG. 2 shows horseshoe 10 upside down, with the ground surface 14 facing up. When attached to the hoof and while the horse is standing or in a stance phase, ground surface 14 (FIG. 2) faces downwardly toward the ground and the support surface 16 (FIG. 1) faces upwardly toward the hoof to which horseshoe 10 is attached.

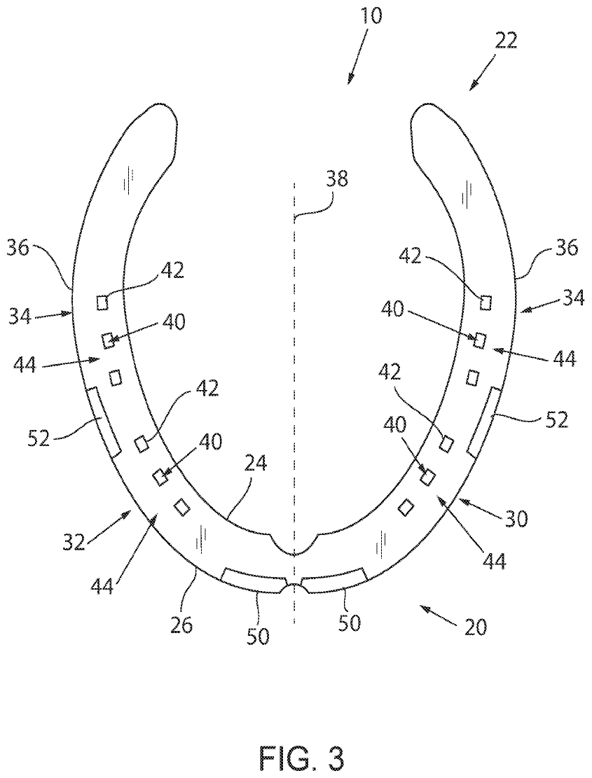

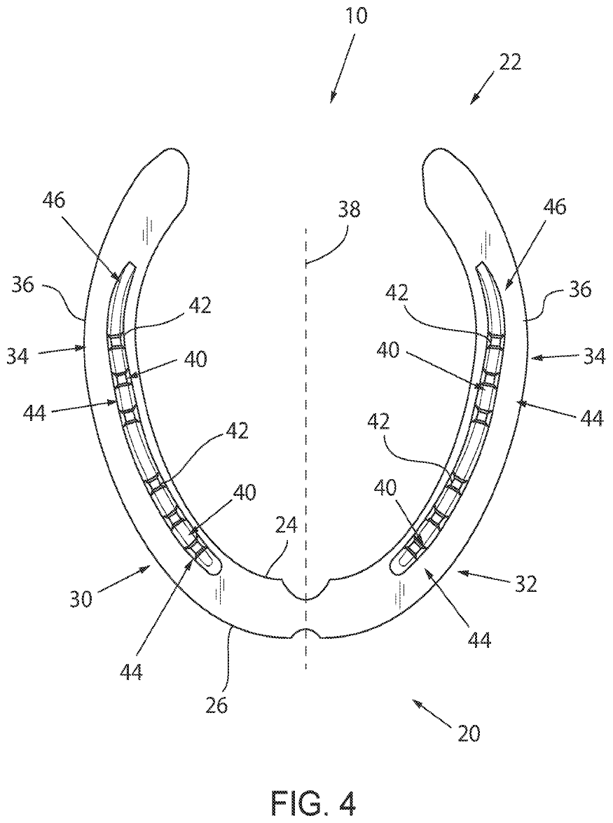

Referring now to FIGS. 3 and 4, horseshoe 10 includes a toe segment or toe 20 at is forward end and the heel segment or heel 22 at its rearward end. An inner circumference or inner perimeter 24 and an outer circumference or outer perimeter 26 are respectively defined by inside and outside edges of the U-shaped body 12 of horseshoe 10. At the sides of horseshoe 10, legs 30, 32 extend from toe 20 toward heel 22. Each of the legs 30, 32 extends along an arcuate path from its forward end at toe 20 toward its respective rearward end at heel 22. Along each leg's curve, an apex area 34 provides a location at which an apex 36 of the curve is defined. A maximum width of horseshoe 10 is defined transversely between the apexes 36 as measured perpendicularly with respect to a centerline 38 of horseshoe 10. Although horseshoe 10 in FIGS. 3-4 is depicted as symmetrical, it is understood that horseshoe 10 may be asymmetrical, for example, as produced or custom formed during the horse shoeing procedure to provide a specific shape or configuration as a therapeutic shoe to fit a particular hoof.

Horseshoe 10 may be secured to the hoof by any of a variety of suitable techniques. For example, securing may be done by way of horseshoe nails, other fasteners, gluing and/or adhesives. The horseshoe 10 of FIGS. 3-4 show one example of a configuration that is suitable for nailing or securing by way of other fasteners. Referring now to FIG. 3, at least two, typically at least three, securing locations 40 are defined at each leg 30, 32. Securing locations 40 are shown here as configured to received fasteners, represented as nail holes 42 that can receive horseshoe nails (not shown) during a shoeing procedure. Nail holes 42 are shown here arranged in multiple sets 44 of nail holes 42, with the sets spaced from each other along the length of each leg 30, 32. The illustrated example shows each leg 30, 32 with two sets 44 of nail holes, each set 44 shown here with three nail holes 42 and with the rearward set(s) 44 extending to the respective apex area 34. Within each set 44, the holes 42 are spaced from each other by a distance, defining an intra-set hole spacing. A spacing between the adjacent sets 44 defines a distance as an inter-set hole spacing. The illustrated example shows the inter-set hole spacing as larger than the intra-set hole spacing.

Referring now to FIG. 4, at each leg 30, 32, in this example, the holes 42 are shown arranged in a nail groove 46. Each nail groove 46 extends along a substantial portion of the leg's length, for example, at least 50% of the leg's length. The holes 42 extend along a substantial portion of the nail groove's length, for example, at least 50% of the nail groove's length. In this way, the securing locations are spread across a major portion of the length of the horseshoe 10, with each leg 30, 32 proving nailing location options from near the toe 20 to near the heel 22. It is understood that for a given number and spacing of holes 42, the longer the length of the nail groove, the less of its length will be occupied by the holes 42. For example, in an implementation of horseshoe 10 as a rim shoe with a groove all around, the holes 42 will extend along a lesser percentage of the groove compared to that in the horseshoe 10 illustrated in FIG. 4. It is understood that in other implementations, the horseshoe 10 does not have nail grooves such as, for example, hind foot slider-type horseshoes, and others without nail grooves.

Referring again to FIG. 3, at each leg 30, 32, at least one toe clip 50 and at least one side clip 52 extend upwardly from the support surface 16 at the outer perimeter 26. The pair of toe clips 50 are adjacent each other at the forward-most end at toe 20 and each side clip 50 is arranged in the respective nail-free gap between the adjacent sets 44 of holes that defines the inter-set hole spacing. In this way, clips 50, 52 and nails in holes 42 provide multiple locating and securing structures that face different directions and support and secure from different orientations. It is understood that the toe clips 50, 52 may result from dividing a single, for example, central, toe clip when converting the dividable horseshoe 10 from the one-piece configuration to the two-piece configuration. The illustrated example shows a securing arrangement that at least partially alternated locating and/or securing features from toe 20 to heel 22, at least to apex area 34, as toe clip 50, at least one nail in nail hole(s) 42 of the forward-most nail hole set 44, side clip 52, and at least one nail hole(s) of the rearward-most nail hole set 44. Regardless of particular arrangement of the nail holes 42 and clips 50, 52, horseshoe 10 is configured so that after is it split or divided from its one-piece horseshoe configuration to its two-piece horseshoe configuration, the nails, other fasteners such as screws, glue or adhesive, or other securing mechanism, maintain each of the halves of the horseshoe 10 in securement to the respective portion of the hoof and independently of each other in a manner that allows accommodates both hoof expansion and contraction while maintaining the integrity of the securement.

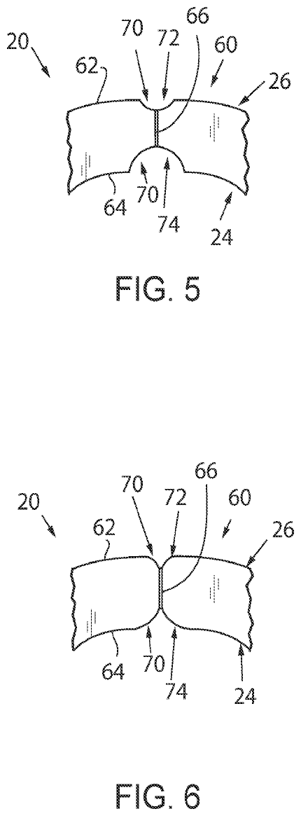

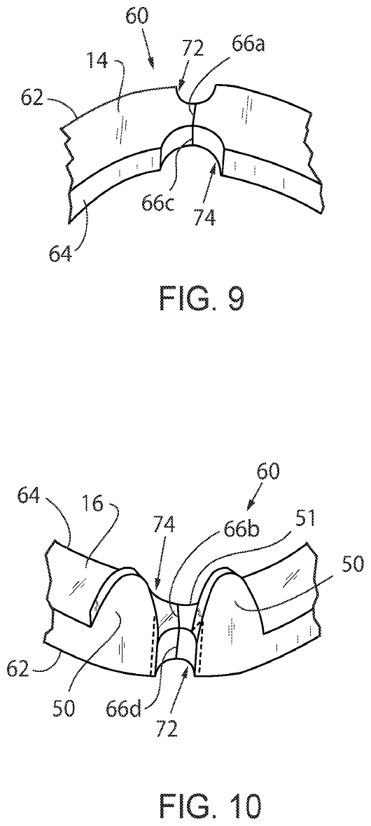

Referring generally to FIGS. 5-10, a bridge segment shown as bridge 60 is defined at toe 20, which is split or divided by a farrier or other equine handler during a shoeing procedure as an initial hoof-care session of the horse shoeing cycle or purposefully afterward during a subsequent hoof-care session of the same horse shoeing cycle. For example, a farrier or other equine handler may split the bridge 60 during the shoeing procedure itself as the initial hoof-care session of the shoeing cycle. Otherwise, the farrier or other equine handler may split the bridge 60 at a later time during a subsequent hoof-care session of the shoeing cycle in which the hoof is already shod with that particular horseshoe 10. Such a subsequent splitting approach may be part of a staged treatment methodology, in which an initial shoeing cycle provides the horseshoe 10 in its one-piece form and it is maintained in the one-piece form during that cycle. This is achieved by the bridge 60 having sufficient rigidity and/or other structural integrity to prevent spontaneous breaking of the horseshoe at the bridge 60, passively during the horse's wearing of horseshoe 10, whereby the splitting of the bridge 60 is timed and controlled by the farrier or other equine handler performing an active and controlled splitting procedure, such as by cutting or the like, at a desired time during a subsequent hoof-care session. Regardless of when bridge 60 is split, after its dividing or splitting, it is configured to allow multi-axial movement of the resultant horseshoe halves. While in the one-piece configuration before dividing or splitting, bridge 60 extends between and connects the legs 30, 32 (FIG. 3) to each other and defines a division zone of the horseshoe 10, at which the horseshoe is configured to be divided to convert its one-piece configuration into its two-piece configuration. Each bridge 60 has forward and rearward bridge walls 62, 64 respectively at the outer and inner perimeters 26, 24 at the forward end of horseshoe 10. The bridge 60 may have a cut groove 66 that provides a visual indicator of a target cut path or a tool alignment aid along which a farrier splits or divides the horseshoe 10. Cut groove 66 is shown extending between the inner and outer perimeters 24, 26 of horseshoe 10 at bridge 60 or between the rearward and forward bridge walls 64, 62, along the horseshoe's longitudinal centerline. Multiple aligned cut grooves 66 that collectively define a single cut or separation path may be implemented at bridge 60, for example, at different surfaces of bridge 60 to facilitate material removal or size reduction of all bridge surfaces to provide concentric thinning of the web of material at bridge 60 along the single cut path. This may be implemented as a continuous cut groove 66 that extends about an entire perimeter of bridge 60, along the horseshoe's centerline. In one example, a cut groove 66 may be provided at each of the ground and support surfaces 14, 16 as groove segments in an aligned overlapping/underlapping arrangement with respect to each other. In another example, additional groove segments or cut grooves 66 may be provided at the front and/or back walls at the inner and outer perimeters 24, 26 or the rearward and forward bridge walls 64, 62, in an aligned leading/trailing arrangement with respect to each other and connecting or projectable to connect respective ends of the grooves 66 at the ground and support surfaces 14, 16 to each other. In such examples, the grooves 66 are always between, typically centered between, the toe clips 50 (FIG. 3) or along the centerline 38 (FIG. 3) so that the grooves 66 are in adjacent planes touching/overlapping each other. As one example, a single point intersects perpendicular planes along which grooves 66 at the support surface 16 and inner perimeter 24 start, with each extending toward its respective end point, transversely with respect to each other. Accordingly, while cutting through groove 66 by starting from ground surface 14, the cutting tool aligns with and engages to remove material from the groove 66 at the ground surface 14 and, while depending of that ground surface 14 groove 66, the cutting tool follows a deepening path that is aligns with and travels through the groove(s) 66 of the forward and/or rearward bridge walls 62, 64. Correspondingly, and referring now to FIGS. 9-10, cut grooves 66 may be provided as: (i) a ground surface groove shown as a horizontal ground cut groove 66a (FIG. 9) at the ground surface 14, (ii) a support surface groove shown as a horizontal support cut groove 66b (FIG. 10) at the support surface 16, (iii) an inner bridge groove shown as a vertical inner cut groove 66c (FIG. 9) at the inner perimeter of the forward bridge wall 62, and (iv) an outer bridge groove shown as a vertical outer cut groove 66d (FIG. 10) at the outer perimeter 26 of the rearward bridge wall 64.

Referring again to FIGS. 5-10, regardless of the particular type and/or location of the cut groove(s) 66, each cut groove 66 is typically implemented as a preformed-score line or channel that recesses into its respective surface and may act as a mechanical guide that locates the tool used to cut the bridge 60. More typically, each cut groove 66 is machined, cast, or otherwise formed with a U-shaped cross-sectional profile, providing a channel or groove with a rounded bottom wall that avoids stress concentrations compared to square or angular corner configurations of intersections between side and bottom walls of the channel that defines groove 66. As explained in greater detail elsewhere herein, grooves 66 are typically deepened as a preliminary fitting step during the shoeing procedure, before the final splitting or dividing of horseshoe 10.

Still referring to FIGS. 5-10, when in the one-piece horseshoe configuration, a clearance 70 extends into one of the forward and rearward bridge walls 62, 64. Typically and as shown in these examples, a pair of clearances 70 forward and rearward bridge walls 62, 64. A first clearance or forward clearance 72 extends into forward bridge wall 62 and a second clearance or rearward clearance 74 extends into the rearward bridge wall 64. So long as the horseshoe 10 can reliably remain in one-piece during a shoeing procedure or initial shoeing cycle without a purposeful split, a substantial amount of material may be devoid of the forward and/or rearward clearances 72, 74 compared to a width of adjacent legs 30, 32 (FIG. 3), such as a depth of greater than 65% or between about 65% and 75% depth compared to an otherwise projection of material following a contour beyond the forward and/or rearward clearances 72, 74. Other implementations may retain substantially more material in the bridge 60, for example, defining a depth of less than 25% or between about 10% to 25% depth of the forward and/or rearward clearances 72, 74 compared to the width of the adjacent legs 30, 32 (FIG. 3).

Referring now to FIG. 5, each of forward and rearward clearances 72, 74 is shown as a concave clearance 70 as a void with a U-shaped profile or perimeter shape that is defined by converging concave surface segments of respective portions of bridge 60. Each half of the clearance 70 on opposite sides of the centerline or cut groove 66 extending initially at a steep angle nearly perpendicularly with respect to the respective forward or rearward wall 62, 64 and then curving to a direction that is substantially perpendicular to the horseshoe centerline at the deepest segment of the clearance 70.

Referring now to FIG. 6, each of forward and rearward clearances 72, 74 is shown as a convex clearance 70 as a void with a teardrop-tail-shaped profile or perimeter shape that is defined by converging convex surface segments of respective portions of bridge 60. Each half of the clearance 70 on opposite sides of the centerline or cut groove 66 extending at a shallow angle nearly tangentially with respect to the respective forward or rearward wall 62, 64 and then curving to a direction that is substantially parallel to the horseshoe centerline at the deepest segment of the clearance 70.

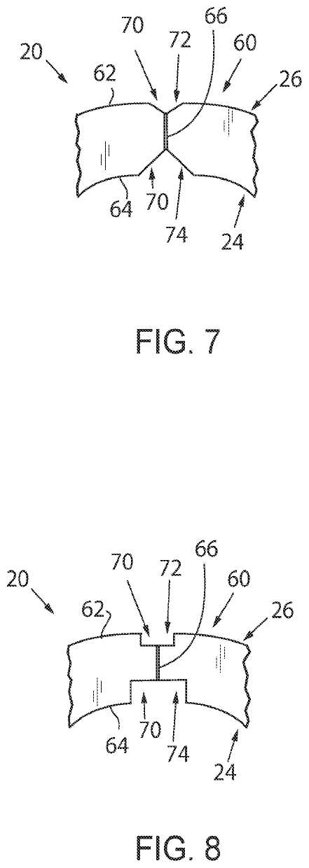

Referring now to FIG. 7, each of forward and rearward clearances 72, 74 is shown as an angular concave clearance 70 as a void with a V-shaped profile or perimeter shape that is defined by converging straight-line surface segments of respective portions of bridge 60. Each half of the clearance 70 on opposite sides of the centerline or cut groove 66 extending at a continuous angle with respect to the respective forward or rearward wall 62, 64 which angularly intersects the horseshoe centerline at the deepest segment of the clearance 70.

Referring now to FIG. 8, each of forward and rearward clearances 72, 74 is shown as a rectangular concave clearance 70 as a void with a rectangular-shaped profile or perimeter shape that is defined by perpendicular straight-line surface segments of respective portions of bridge 60. Each of the forward and rearward clearances 72, 74 defines a substantially constant depth of void space along its respective width.

Referring again generally to FIGS. 5-10, although shown with paired analogous types of clearances 70 such as U-shaped concave (FIG. 5), teardrop-tail-shaped concave (FIG. 6), V-shaped or other angular concave (FIG. 7), and rectangular concave (FIG. 8), it is understood that bridge 60 may implement clearances with different general perimeter shapes than those shown, or different configurations as the forward and rearward clearances 72, 74 and it is further understood that the bridge 60 may implement only a single clearance 70. Regardless of the particular configuration(s) of the clearance(s) 70, the combination of the split between the horseshoe 10 halves and the space(s) provided by the clearance(s) 70 allow the horseshoe halves to move three-dimensionally with respect to each other. This includes transversely pivoting about a pivot axis, typically defined at the horseshoe centerline through a mid-point between the bridge's forward and rearward wall 62, 64, while avoiding collisions between corresponding surfaces of the split or divided bridge, whereby the clearances 72, 74 allow for unrestricted expansion and contraction of the hoof. In this way, forward clearances 72 define hoof expansion clearances and rearward clearances 74 define hoof contraction clearances that, together, facilitate such unrestricted expansion and contraction of the hoof in manners that cannot be achieved through or is greater that what is facilitated by, e.g., cracked separation or cut/kerf only separation of the bridge wall 62.

Referring now to FIGS. 9-10, a typical relationship of relative sizes of the forward and rearward clearances and their arrangement(s) with respect to toe clips 50 (FIG. 10) is shown. The shapes of clearances 72, 74 and their size(s) are typically configured to remove as little material from the horseshoe 10 as possible to optimize hoof wall support and sole support while simultaneously facilitating the hoofs natural expansion and contraction of the hoof mechanism. Each of the forward and rearward clearances 72, 74 defines a width dimension that is narrow enough to maintain substantial strength of the bridge 60 to maintain the horseshoe's one-piece configuration, until the farrier or other equine handler purposely splits the bridge 60, typically less than 10 mm for the forward clearance 72 and typically less than 15 mm for the rear clearance 74. After splitting, the width of forward clearance 72 is wide enough to allow a natural amount of heel expansion yet narrow enough to provide uncompromised support of the hoof wall at the toe. Likely, after splitting, the width of rearward clearance 74 is wide enough to allow a natural amount of heel contraction yet narrow enough to provide uncompromised support of the hoof's sole at the toe. Regardless, of the particular width dimension of rearward clearance 74, it is typically wider than a width dimension of the forward clearance 72 and a space or gap 51 (FIG. 10) defined between the pair of toe clips 50. As shown in FIG. 9, the center of the rearward clearance 74 is directly opposite the center of the forward clearance 72. A width dimension of the rearward clearance 74 may be greater than 1.5-times the width dimension of the forward clearance 72, typically about 2-times the width dimension of the forward clearance 72. Referring now to FIG. 10, the rearward clearance may be greater than 1.5-times the width dimension of the toe clip gap 51, typically at least about 2-times the width dimension of the toe clip gap 51, such as about 4-times the width dimension of the toe clip gap 51. As shown in FIG. 10, in some implementations, forward/inward generally vertical edges of the toe clips 50 may coincide with forward/inward generally vertical edges that define the outermost opening of forward clearance 72. In the illustrated example, the inner sidewalls of toe clips 50, which face inwardly toward a centerline of horseshoe 10 and thus also face toward each other, are shown projecting upwardly as extensions from or coplanar with sidewall segments of the outermost portions of forward clearance 72, adjacent the bridge's forward wall 62. Furthermore, as represented by the vertical dashed lines, the forward clearance 72 may include a void spaced defined by some material that is removed from or otherwise devoid of the forward surface(s) of the toe clips 50, whereby the size of the opening of the forward clearance 72 and the distance between the toe clips 50 at their forward most surfaces are the same. Correspondingly, the forward clearance 72 at the front wall may have a maximum distance or width dimension that is equal to the distance between the toe clips 50 or the dimension of the toe clip gap 51. It is noted that although the forward clearance 72 may extend to the toe clips 50 in this manner, it will typically not extend beyond the toe clips 50 to provide sufficient strength to maintain the structural integrity of the toe clips 50.

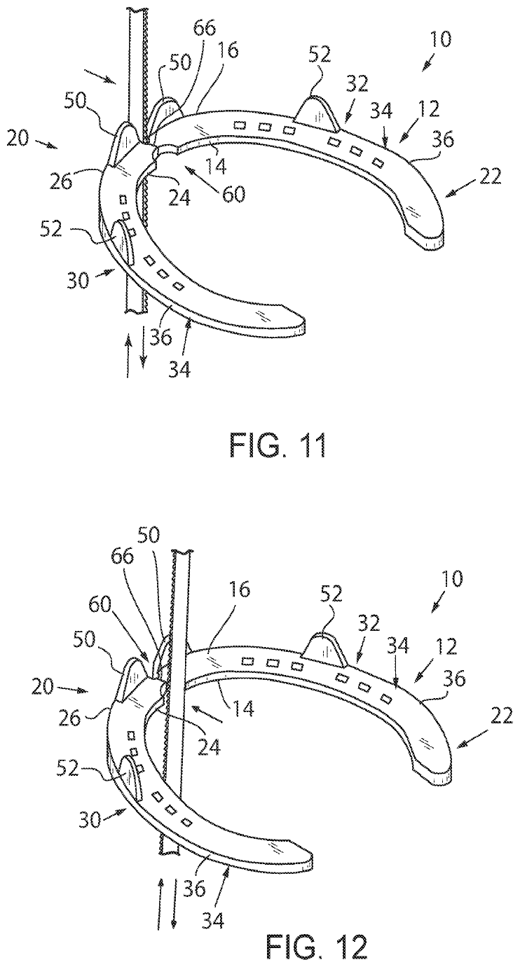

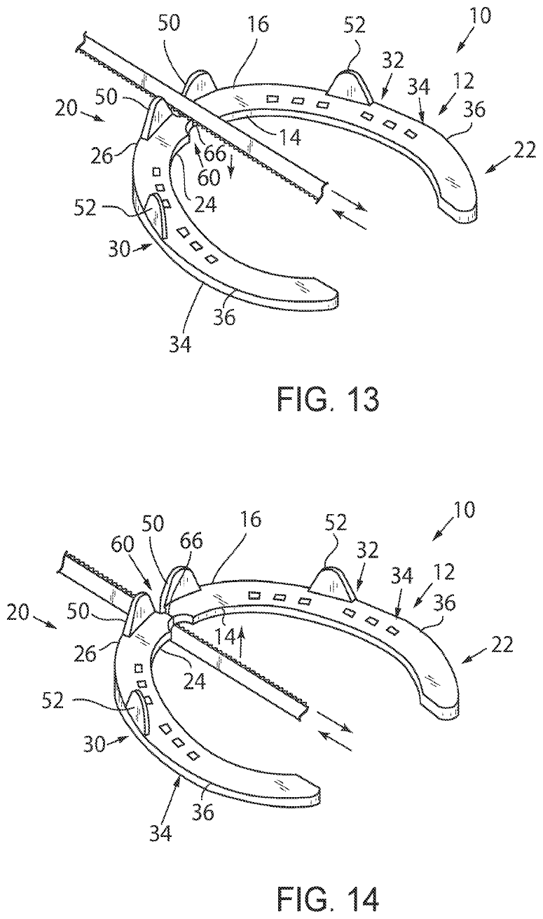

Referring now generally to FIGS. 11-16, a typical shoeing procedure is represented, which includes pre-deepening of the cut groove(s) 66, securing the horseshoe to a hoof, and splitting or dividing the installed shoe during the shoeing procedure as a shoeing-phase splitting procedure or purposefully after the shoeing procedure in a subsequent hoof-care session, during a shod-phase splitting procedure. Referring now to FIG. 11, a cut groove 66 at forward bridge wall 62 is deepened by, for example, sawing or grinding with a corresponding suitable tool such as a saw, file, or grinder. Referring now to FIG. 12, a cut groove 66 at rearward bridge wall 64 is deepened using the tool. Referring now to FIG. 13 a cut groove 66 at support surface 16 is deepened using the tool. Referring now to FIG. 14 a cut groove 66 at ground surface 14 is deepened using the tool. At this point the material at bridge 60 have been reduced, for example, by deepening the cut grooves 66 about an entire periphery of bridge 60, to substantially reduce the amount of material that needs to be cut in the final splitting or dividing while leaving sufficient material to provide enough strength to prevent splitting or diving while securing the horseshoe 10 to the hoof. This may be done by removing at least about 25% of the material collectively from below the cut grooves 66 or reducing the cross-section area of the web of material inward of the cut grooves 66 to about 75% before the material removal. The particular amount of material removed typically depends on, for example, the material from which the horseshoe is made with more material removed from stronger materials and less material removed from less strong materials. Horseshoe 10 can be made from any of a variety of suitable metallic and non-metallic materials. Metallic implementations are typically made from, for example, various ferrous materials such as steel or non-ferrous materials such as aluminum. Non-metallic implementations are typically made from, for example, various composite materials such as resinous fiber-reinforced materials, polymeric materials such as polyurethane, including various cast versions of the same, examples of which include Kevlar/cast types.

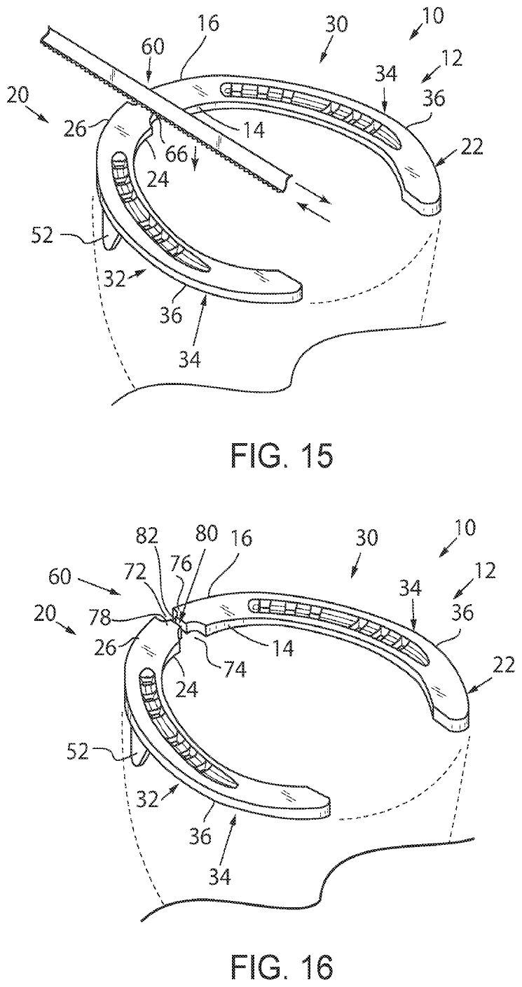

Still referring to FIGS. 11-16, after the pre-deepening or material removal, then the horseshoe 10 is secured to the hoof, for example, by way of horseshoe nails, other fasteners including screws, gluing and/or adhesives. Referring now to FIG. 15, the final splitting or dividing of horseshoe 10 from its one-piece configuration to its two-piece configuration may be done during the shoeing procedure while the horseshoe is secured to the hoof as a shoeing-phase splitting procedure or after shoeing during a shod-phase splitting procedure. This is done by cutting the remainder of typically narrowed/reduced material below cut groove 66 at the ground surface 14. Referring now to FIG. 16, after the final splitting or dividing, the horseshoe defines a pair of horseshoe halves that are fully independent of each other, separated by a kerf-gap with a width dimension that corresponds to a width dimension of the tool's blade or other cutting device and, accordingly, a width of the amount of material that was removed by cutting or otherwise dividing the horseshoe 10 during the splitting procedure.

Still referring to FIG. 16, paired and separated first and second side bridge segments 76, 78 are defined after the horseshoe's division. The portions of the first and second side bridge segments that are nearest each other are at an intermediate segment of the bridge 60, where the kerf-gap, shown here as gap 80, is defined. Gap 80 provides a third clearance as an intermediate clearance 82, defined by a space that extends in a straight-line between and connects the voids of the forward and rearward clearances 72, 74 to each other. In this way, the portions of the first and second side bridge segments 76, 78 that provide transverse boundaries of gap 80 are equally spaced from each other in a default or resting state of the hoof. The reminder of the first and second side bridge segments 76, 78 are increasingly spaced further from each other transversely as they as the extend in a longitudinal direction away from the ends of the gap 80, as defined by the configuration of the clearances 70 that provide collision-preventing voids toward the forward and rearward bridge walls 62, 64. Gap 80 may be substantially narrower than each of the forward and rearward clearances 72, 74. The forward clearance 72 may be narrower and shallower than the rearward clearance 74. Typically, a widest portion of the forward clearance 72 is at least twice as wide as gap 80 and, more typically, at least three times as wide as gap 80, such as between three times and ten times as wide as gap 80. Typically, a widest portion of the rearward clearance 74 is at least three times as wide as gap 80 and, more typically, at least five times as wide as gap 80, such as between five times and fifteen times as wide as gap 80. A width dimension of forward clearance 72 can be up to about 1 cm and is typically less than about 0.75 cm, measured at its widest segment at its opening at forward bridge wall 62. A width dimension of rearward clearance 74 can be up to about 2 cm and is typically less than about 1.5 cm, measured at its widest segment at its opening at rearward bridge wall 64. Typically, the depth of rearward clearance 74 is greater than that of forward clearance 72, more typically and least twice as deep, such as between two times and five times the depth of forward clearance 72. A length dimension of gap 80 is typically greater than depth dimensions of each of the forward and rearward clearances 72, 74, and the length of gap 80 may be greater than the combined depths of the forward and rearward clearances 72, 74 so that the combined depths of the forward and rearward clearances 72, 74 is less than one-half of the projected material width of bridge 60, which would correspond to the distance between the forward and rearward bridge walls 62, 64, if there were no clearances 72, 74 in the bridge 60. A depth dimension of forward clearance 72 can be up to about 1 cm and is typically less than one-half of the projected material width of bridge 60, more typically less than one-quarter of the projected material width of bridge 60, for example, about one-sixth of the projected material width of bridge 60. A depth dimension of rearward clearance 74 can be up to about 2 cm and is typically less than one-half of the projected material width of bridge 60, more typically about one-third of the projected material width of bridge 60.

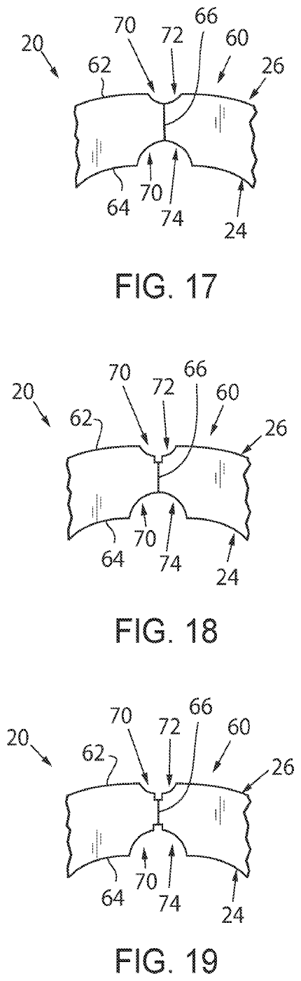

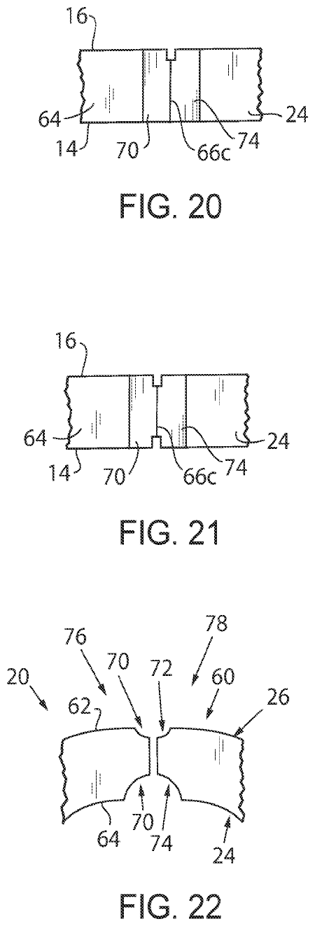

Referring now to FIGS. 17-22, bridge 60 is shown at various states of the pre-deepening of the cut groove(s) 66 as well as the final splitting or dividing, correspond to that show in FIGS. 11-16. FIG. 17 shows bridge 60 with a visible cut groove 66 before any pre-deepening. FIG. 18 shows a pre-deepening of a cut groove 66 at forward bridge wall 62. FIG. 19 shows an additional pre-deepening of a cut groove 66 at rearward bridge wall 64. FIG. 20 shows an additional pre-deepening of a cut groove 66 at the support surface 16. FIG. 21 shows an additional pre-deepening of a cut groove 66 ground surface 14, leaving a web of material that has been reduced about an entire periphery of bridge 60 at the horseshoe's centerline. FIG. 22 shows the fully divided bridge 60, with the first and second bridge segments 76, 78 spaced equally from each other at the kerf-gap and then increasing spaced further from each other in a traverse direction further from ends of the gap 80.

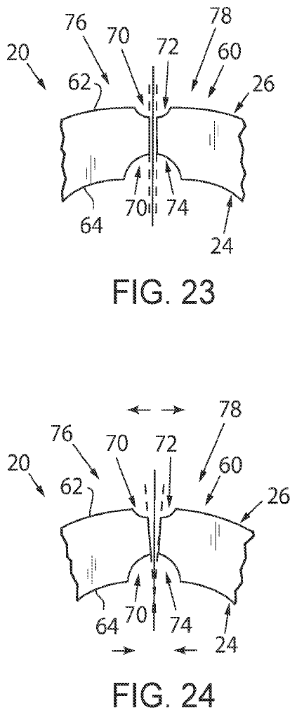

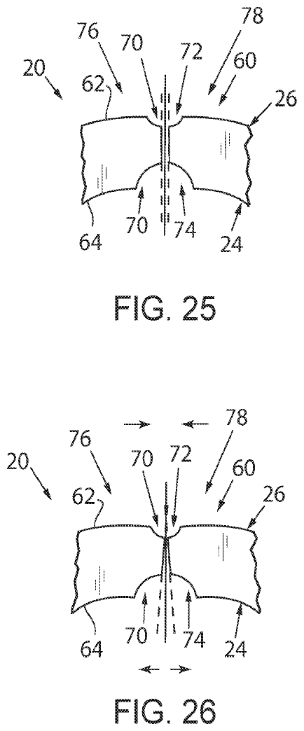

Referring now generally to FIGS. 23-26, transversely pivot movement of the first and second bridge segments 76, 78 with respect to each other is represented, schematically showing the substantial movement facilitated by the collision-preventing voids toward the forward and rearward bridge walls 62, 64. Movement of first and second bridge segment 76, 78 between FIGS. 23-24 corresponds to a hoof's heel contraction that tends to pull the rearward ends of horseshoe legs 30, 32 (FIG. 3) toward each other and the rearward segments of first and second bridge segments 76, 78 toward each other. This movement typically allows for at least some independent movement of the first and second bridge segments 76, 78 with respect to each other, which include movement about a pivot axis. In some implementations, such movement about the pivot axis may define about two-degrees and more typically about 5-degrees of movement about the pivot axis. Movement of first and second bridge segment 76, 78 between FIGS. 25-26 corresponds to a hoof's heel expansion that tends to push the rearward ends of horseshoe legs 30, 32 (FIG. 3) away each other and the rearward segments of first and second bridge segments 76, 78 away from each other. This movement typically allows for at least about two-degrees and more typically about 5-degrees of movement about the pivot axis, in the opposite direction of pivoting when compared to the heel contraction.

Although the horseshoe(s) 10 is represented as a hind or rear horseshoe, it is understood that the features and configurations apply equally to front horseshoes. Typically, compared to rear horseshoes, front horseshoes are relatively wider/rounded at their front ends or less pointy. The general concepts described and shown can be implemented in front horseshoes, while noting that particular interactions and relative movements when in the divided state will vary somewhat based on the particular geometries of the interacting segments, including surfaces and clearances, which may differ between rear and front horseshoes. Besides applying equally to front and rear horseshoes, it is further noted that the features and configurations can be implemented with all different sizes and categories of horseshoes, including, for example, specialty horseshoes such as orthopedic horseshoes and/or others.

Other aspects and characteristics of a dividable horseshoe 10 falling within the scope of the present invention are disclosed in the drawings attached hereto.

Many changes and modifications could be made to the invention without departing from the spirit thereof. The scope of these changes will become apparent from the appended claims.

What is claimed is:

1. A dividable horseshoe that is dividable from a one-piece horseshoe into a two-piece horseshoe during a horse shoeing procedure in which the dividable horseshoe is attached to a hoof of a horse, the dividable horseshoe comprising:
a ground surface that faces downwardly toward the ground when the dividable horseshoe is attached to the hoof of the horse;
a support surface that faces upwardly away from the ground when the dividable horseshoe is attached to the hoof of the horse;
a first leg arranged at a first side of the dividable horseshoe;
a first side clip extending upwardly from the first leg to transversely locate the first leg with respect to the hoof;
a second leg arranged at a second side of the dividable horseshoe;
a second side clip extending upwardly from the second leg to transversely locate the second leg with respect to the hoof;
a bridge extending between the first and second legs with the bridge including:
a forward bridge wall defined at a forward-facing outer perimeter of the dividable horseshoe;
a rearward bridge wall defined at a rearward facing inner perimeter of the dividable horseshoe;
a first side bridge segment connected to the first leg;
a first toe clip extending upwardly from the first side bridge segment to longitudinally locate the first leg with respect to the hoof;
a second side bridge segment connected to the second leg;
a second toe clip extending upwardly from the second side bridge segment to longitudinally locate the second leg with respect to the hoof;
wherein:
when the dividable horseshoe is in an undivided state, the first and second bridge segments are connected to each other;
when the dividable horseshoe is in a divided state, the first and second bridge segments are separated from each other;
a clearance extending into the forward bridge wall, with the clearance defined between the first and second toe clips and defining a clearance width dimension that is equal to or less than a distance between the first and second toe clips.

2. The dividable horseshoe of claim 1, wherein the clearance accommodates pivoting of the first and second legs toward or away from each other at an angle of at least two-degrees about a pivot axis that extends orthogonally from a centerline of the dividable horseshoe.

3. The dividable horseshoe of claim 2, wherein when the dividable horseshoe is in the divided state and the hoof flexes during use the clearance accommodates movement of the first and second legs with respect to each other in three dimensions.

4. The dividable horseshoe of claim 1, wherein:
the clearance that extends into the forward bridge wall defines a first clearance;
the first clearance accommodates pivoting of the first and second legs away from each other to decrease a first distance between the first and second bridge segments at the divided forward bridge wall during a heel expansion event of the hoof;
a second clearance extends into the rearward bridge wall; and
the second clearance accommodates pivoting of the first and second legs toward each other to decrease a second distance between the first and second bridge segments at the divided rearward bridge wall during a heel contraction event of the hoof.

5. The dividable horseshoe of claim 4, wherein at least one of the first and second clearances defines at least one of:
a curvilinear profile shape;
a concave perimeter shape;
a rectangular perimeter shape;
a U-shaped perimeter shape; and
a straight-line-angular perimeter shape.

6. The dividable horseshoe of claim 1, further comprising
a support surface groove that extends into the support surface at the bridge;
a ground surface groove that extends into the ground surface at the bridge; and at least one of:
an inner bridge groove that extends into an inner perimeter of the forward bridge wall; and
an outer bridge groove that extends into an outer perimeter of the rearward bridge wall.

7. The dividable horseshoe of claim 6, wherein each of the support surface groove and the ground surface groove extends between the first and second clearances.

8. The dividable horseshoe of claim 4, wherein the first and second clearances define different perimeter shapes.

9. The dividable horseshoe of claim 1, wherein each of the first and second horseshoe legs is secured to the hoof through at least three securing locations.

10. The dividable horseshoe of claim 9, wherein the at least three securing locations at each of the first and second horseshoe legs are defined by at least three fasteners that secure the respective one of the first and second horseshoe legs to the hoof.

11. The dividable horseshoe of claim 10, wherein the fasteners are horseshoe nails.

12. The dividable horseshoe of claim 10, wherein each of the first and second horseshoe legs includes at least four holes with the at least three fasteners extending through at least three of the at least four holes.

13. The dividable horseshoe of claim 12, wherein at each of the first and second horseshoe legs, a first set of holes is arranged closer to the rear of the horseshoe and a second set of holes is arranged closer to the front of the horseshoe and wherein a space between the first and second sets is greater than a space between adjacent holes within each set.

14. The dividable horseshoe of claim 13, wherein the inter-set hole spacing is greater than the intra-set hole spacing of each of the sets of multiple holes.

15. The dividable horseshoe of claim 14, wherein at least some of the holes are arranged substantially at a widest segment of the dividable horseshoe.

16. The dividable horseshoe of claim 15, wherein each of the first and second horseshoe legs is secured to the hoof through at least two securing locations in which:
a first one of the at least two securing locations is arranged forward of the side clip; and
a second one of the at least two securing locations is arranged rearward of the side clip.

17. The dividable horseshoe of claim 4, wherein the first and second clearances define different dimensions.

18. A method of shoeing a horse during a horse shoeing cycle with a dividable horseshoe that includes first and second legs respectively at first and second sides of the dividable horseshoe and a bridge that includes a pair of toe clips and connects the first and second legs to each other, wherein the dividable horseshoe is dividable from:
a first configuration as a one-piece horseshoe that includes:
a ground surface that faces downwardly toward the ground when the dividable horseshoe is attached to a hoof of a horse;
a support surface that faces upwardly away from the ground when the dividable horseshoe is attached to the hoof of the horse,
into a second configuration as a two-piece horseshoe during or after the shoeing procedure, the method comprising:
providing a clearance in the bridge;
attaching the dividable horseshoe in the first configuration as a one-piece horseshoe to the hoof;
dividing the bridge at a dividing location that extends between the pair of toe clips and aligns with the clearance in the bridge to provide first and second horseshoe pieces defined by the first and second legs and respective first and second segments of the bridge at opposing sides of the dividing location.

19. The dividable horseshoe of claim 18, wherein the dividing the bridge step occurs during an initial hoof-care session of the horse shoeing cycle during which the dividable horseshoe is attached to the hoof.

20. The dividable horseshoe of claim 19, wherein the dividing the bridge step occurs during a subsequent hoof care session of the shoeing cycle after the initial shoeing procedure and during which the dividable horseshoe is attached to the hoof.

21. A dividable horseshoe that is dividable from a one-piece horseshoe into a two-piece horseshoe during a horse shoeing procedure in which the dividable horseshoe is attached to a hoof of a horse, the dividable horseshoe comprising:
a first leg arranged at a first side of the dividable horseshoe;
a first side clip extending upwardly from the first leg to transversely locate the first leg with respect to the hoof;
a second leg arranged at a second side of the dividable horseshoe;
a second side clip extending upwardly from the second leg to transversely locate the second leg with respect to the hoof;
a bridge arranged at a toe segment of the dividable horseshoe and extending between the first and second legs with the bridge including:
a forward bridge wall defined at a forward-facing outer perimeter of the dividable horseshoe;
a rearward bridge wall defined at a rearward facing inner perimeter of the dividable horseshoe;
a first side bridge segment connected to the first leg;
a first toe clip extending upwardly from the first side bridge segment to longitudinally locate the first leg with respect to the hoof;
a second side bridge segment connected to the second leg;
a second toe clip extending upwardly from the second side bridge segment to longitudinally locate the second leg with respect to the hoof;
at least one clearance extending into at least one of the forward bridge wall and the rearward bridge wall, with the at least one clearance facilitating a pivot-type movement of the first and second bridge segments with respect to each other when the dividable horseshoe is in the divided state to accommodate at least one of heel expansion and heel contraction of the hoof; and
wherein:
when the dividable horseshoe is in an undivided state, the first and second bridge segments are connected to each other; and
when the dividable horseshoe is in a divided state, the first and second bridge segments are separated from each other.

22. The dividable horseshoe of claim 21, wherein the at least one clearance is defined by a forward clearance that extends into the forward bridge wall with the forward clearance configured to accommodate heel expansion of the hoof when the dividable horseshoe is in the divided state.

23. The dividable horseshoe of claim 21, wherein the at least one clearance is defined by a rearward clearance that extends into the rearward bridge wall with the rearward clearance configured to accommodate heel contraction of the hoof when the dividable horseshoe is in the divided state.

24. The dividable horseshoe of claim 21, wherein the at least one clearance is defined by:
a forward clearance that extends into the forward bridge wall with the forward clearance configured to accommodate heel expansion of the hoof when the dividable horseshoe is in the divided state; and
a rearward clearance that extends into the rearward bridge wall with the rearward clearance configured to accommodate heel contraction of the hoof when the dividable horseshoe is in the divided state.

25. The dividable horseshoe of claim 24, wherein when the dividable horseshoe is in the undivided state:
the forward clearance defines a first width dimension; and
the rearward clearance defines a second width dimension that is greater than the first width dimension.

26. The dividable horseshoe of claim 24, wherein when the dividable horseshoe is in the undivided state:
the forward clearance defines a first depth dimension; and
the rearward clearance defines a second depth dimension that is greater than the first depth dimension.

27. The dividable horseshoe of claim 24, wherein when the dividable horseshoe is in the undivided state the forward and rearward clearances define at least one of:
a concave perimeter shape;
a convex perimeter shape;
a U-shaped perimeter shape;
a teardrop-tail shaped perimeter shape;
a V-shaped perimeter shape; and
a rectangular shaped perimeter shape.

28. A dividable horseshoe that is dividable from a one-piece horseshoe into a two-piece horseshoe during a horse shoeing procedure in which the dividable horseshoe is attached to a hoof of a horse, the dividable horseshoe comprising:
a ground surface that faces downwardly toward the ground when the dividable horseshoe is attached to the hoof of the horse;
a support surface that faces upwardly away from the ground when the dividable horseshoe is attached to the hoof of the horse;
a first leg arranged at a first side of the dividable horseshoe;
a second leg arranged at a second side of the dividable horseshoe;
a bridge arranged at a toe segment of the dividable horseshoe and extending between the first and second legs with the bridge including:
a forward bridge wall defined at a forward-facing outer perimeter of the dividable horseshoe;
a rearward bridge wall defined at a rearward facing inner perimeter of the dividable horseshoe;
a bridge lower wall defined at the ground surface of the bridge;
a bridge upper wall defined at the support surface of the bridge;
a groove that extends into at least one of the forward bridge wall and the rearward bridge wall for aligning a tool for dividing the dividable horseshoe.

29. The dividable horseshoe of claim 28, wherein the groove includes a forward groove segment that extends into the forward bridge wall and a rearward groove segment that extends into the rearward bridge wall when the dividable horseshoe is in an undivided state.

30. The dividable horseshoe of claim 29, wherein the groove further includes a lower groove segment that extends into the bridge lower wall and an upper groove segment that extends into the bridge upper wall, with the forward groove segment, the rearward groove segment, the lower groove segment, and the upper groove segment connected to each other as respective segments of the groove extending about an entire perimeter of the bridge.
